(19) United States
(12) Patent Application Publication
(10) Pub. No.: US 2026/0274363 A1
(43) Pub. Date: Sep. 17, 2026

(54) STRAP-TYPE MOBILE DEVICE HOLDER

(71) Applicant: Bone Collection Inc., New Taipei City (TW)

(72) Inventor: Chin-Sheng LIN, New Taipei City (TW)

(21) Appl. No.: 19/203,578

(22) Filed: May 9, 2025

(30) Foreign Application Priority Data
Mar. 13, 2025 (TW) 114109402

(51) Int. Cl. B62J 11/00; B60R 11/00; B60R 11/02

(52) U.S. Cl. CPC B62J 11/00; B60R 11/0241; B60R 2011/0059; B60R 2011/0071

(57) ABSTRACT

A strap-type mobile device holder including a holder body, a first elastic strap and a second elastic strap. The holder body is provided with a secure structure configured to secure the mobile device. The first elastic strap includes a first solid section and a first perforated section. The first solid section is provided with a first buckle portion. The first perforated section is provided with a first perforation and a first buckle hole. The second elastic strap includes a second solid section and a second perforated section. The second solid section is provided with a second buckle portion. The second perforated section is provided with a second perforation and a second buckle hole. When fastening the strap-type mobile device holder secured with the mobile device onto a carrier, the first elastic strap passes through the second perforation or the second elastic strap passes through the first perforation.

### CROSS-REFERENCE TO RELATED APPLICATION

This application claims the priority benefit of Taiwan Patent Application No. 114109402, filed on Mar. 13, 2025. The entirety of the above-mentioned patent application is hereby incorporated by reference herein and made a part of the specification.

### BACKGROUND OF THE INVENTION

### Field of the Invention

The present invention generally relates to a mobile device holder and, more particularly, to a strap-type mobile device holder.

### Description of the Related Art

In recent years, with the rise of fitness awareness, more and more people have chosen to ride a bicycle as a means of daily commuting or recreational exercise. This trend not only reflects people's yearning for a healthy lifestyle but also demonstrates an emphasis on environmentally friendly transportation.

During bicycle riding, a smart phone has become an indispensable auxiliary tool. It can not only track various exercise data, such as riding distance, speed, and calories consumed, but also record exercise time, play music, and even provide real-time navigation to help riders find the optimal route.

However, holding a smart phone while riding is not only inconvenient but may also pose safety risks. To address these issues, conventional technologies have developed a mobile device holder configured to be installed on a bicycle after securing a smart phone.

Please refer to FIG. 1 to FIG. 3, where FIG. 1 shows a perspective schematic diagram of a prior-art mobile device holder; FIG. 2 shows a perspective schematic diagram of a prior-art mobile device holder fastened onto a carrier after securing a mobile device; and FIG. 3 shows a cross-sectional schematic diagram of a prior-art mobile device holder. As shown in FIG. 1 and FIG. 2, a mobile device holder PA100 is configured to be fastened onto a bicycle PA300 (for example, onto a handlebar or stem of a bicycle) after securing a smart phone PA200.

The mobile device holder PA100 includes a holder body PA1, a first elastic strap PA2, and a second elastic strap PA3. The holder body PA1 is provided with a secure structure PA11 configured to secure the smart phone PA200 (illustrated in the figures as a plurality of elastic binding cords configured to wrap around and secure the smart phone PA200).

The first elastic strap PA2 and the second elastic strap PA3 extend outward opposite each other from the holder body PA1. The first elastic strap PA2 is provided with a perforation PA21 away from the holder body PA1. The second elastic strap PA3 is provided with a plurality of buckle holes (where only one buckle hole PA31 is marked) away from the holder body PA1 and a buckle portion PA32 adjacent to the holder body PA1.

When fastening the mobile device holder PA100, which secures the smart phone PA200, onto the bicycle PA300, the buckle hole PA31 loops back to the buckle portion PA32 after the second elastic strap PA3 passes through the perforation PA21, such that the buckle hole PA31 is engaged with the buckle portion PA32 to complete the installation.

As shown in FIG. 3 (where the cross-sectional schematic diagram is for reference only, and the perspective structure of the prior art is primarily illustrated in FIG. 1 and FIG. 2), after the mobile device holder PA100 is fastened onto the bicycle PA300, due to the difference in length between the first elastic strap PA2 and the second elastic strap PA3, and the side-offset position where the buckle hole PA31 is engaged with the buckle portion PA32 (towards the second elastic strap PA3), the first elastic strap PA2 and the second elastic strap PA3 undergo different amounts of elastic deformation.

This means that when the elastic recovery forces (in the form of friction) of the first elastic strap PA2 and second elastic strap PA3 act on the bicycle PA300 surface, they cannot mutually cancel out and thus produce an unbalanced torque. As a result, when the bicycle PA300 experiences vibrations during movement, the mobile device holder PA100 tends to gradually flip over and require re-positioning.

Additionally, the prior-art mobile device holder PA100 only has one buckle portion PA32. If the bicycle PA300 vibrates during movement, causing the buckle hole PA31 to detach from the buckle portion PA32, the mobile device holder PA100 may immediately fall off, potentially causing damage to the smart phone PA200.

### BRIEF SUMMARY OF THE INVENTION

In view of the prior art, where the first elastic strap PA2 and second elastic strap PA3 of mobile device holder PA100 exhibit different amounts of elastic deformation after being fastened onto the bicycle PA300, it is prone that the mobile device holder PA100 gradually flips over and requires re-positioning. Moreover, since the prior-art mobile device holder PA100 only has one buckle portion PA32, if vibrations during the movement of the bicycle PA300 cause the buckle hole PA31 to detach from the buckle portion PA32, the mobile device holder PA100 may immediately fall off, potentially causing damage to the smart phone PA200.

One objective of the present invention is to provide a strap-type mobile device holder that uses a first elastic strap and a second elastic strap of equal (or similar) length to create a bidirectional buckle mechanism onto a carrier. With symmetrically positioned buckles, the elastic recovery forces can counteract each other to prevent unbalanced torque, thereby avoiding the strap-type mobile device holder from rotating due to vibrations when the carrier is in motion. Additionally, since the strap-type mobile device holder of the present invention is provided with two buckle portions, when vibrations of the carrier cause one buckle hole to detach from a buckle portion, the other buckle portion can still secure the strap-type mobile device holder onto the carrier, effectively preventing the mobile device from being damaged due to falling.

Accordingly, to address the issues in the prior art, the necessary technical means adopted by the present invention is to provide a strap-type mobile device holder configured to fasten a mobile device to a selected fixed position on a carrier after securing the mobile device so that it remains fastened to the selected fixed position even when the carrier is in motion. Preferably, the strap-type mobile device holder is an integrally formed component.

The strap-type mobile device holder includes a holder body, a first elastic strap, and a second elastic strap. The holder body is provided with a secure structure configured to secure the mobile device, and has a first connecting portion and a second connecting portion positioned opposite each other. Preferably, the holder body is an integrally formed component. Preferably, the secure structure includes a plurality of elastic loop cords configured to elastically wrap around and secure the mobile device. Preferably, the secure structure includes a plurality of elastic protective sleeves configured to elastically wrap around and secure the mobile device.

The first elastic strap includes a first solid section and a first perforated section. The first solid section extends outward from the first connecting portion in a direction away from the second connecting portion, and is provided with a first buckle portion. The first perforated section extends outward from the first solid section in a direction away from the holder body, and is provided with a first perforation positioned adjacent to the first solid section and at least one first buckle hole positioned away from the first solid section. Preferably, the first elastic strap is an integrally formed component.

The second elastic strap includes a second solid section and a second perforated section. The second solid section extends outward from the second connecting portion in a direction away from the first connecting portion, and is provided with a second buckle portion. The second perforated section extends outward from the second solid section in a direction away from the holder body, and is provided with a second perforation adjacent to the second solid section and at least one second buckle hole positioned away from the second solid section. Preferably, the second elastic strap is an integrally formed component.

When fastening the strap-type mobile device holder secured with the mobile device onto the selected fixed position on the carrier, the first elastic strap loops around the carrier and passes through the second perforation or the second elastic strap loops around the carrier and passes through the first perforation, such that the at least one first buckle hole engages with the second buckle portion and the at least one second buckle hole engages with the first buckle portion, thereby securing the strap-type mobile device holder onto the selected fixed position by a bidirectional buckle mechanism.

Based on the aforementioned necessary technical means, the following auxiliary technical means can be derived. Preferably, the first perforated section is provided with a plurality of first buckle holes, and the second perforated section is provided with a plurality of second buckle holes, configured to selectively engage one of the first buckle holes with the second buckle portion, and configured to selectively engage one of the second buckle holes with the first buckle portion, thereby adjusting the fastening torque of the first and second elastic straps to the selected fixed position.

In summary, the strap-type mobile device holder provided by the present invention uses a first elastic strap and a second elastic strap of equal (or similar) length to create a bidirectional buckle mechanism onto a carrier. With symmetrically positioned buckles, the elastic recovery forces can counteract each other to prevent unbalanced torque, thereby avoiding the strap-type mobile device holder from rotating due to vibrations when the carrier is in motion.

Additionally, since the strap-type mobile device holder of the present invention is provided with two buckle portions, when vibrations of the carrier cause one buckle hole to detach from a buckle portion, the other buckle portion can still secure the strap-type mobile device holder onto the carrier, effectively preventing the mobile device from being damaged due to falling.

The embodiments of the present invention will be further explained through the following examples and drawings.

### BRIEF DESCRIPTION OF THE DRAWINGS

FIG. 1 is a perspective schematic diagram of a prior-art mobile device holder;

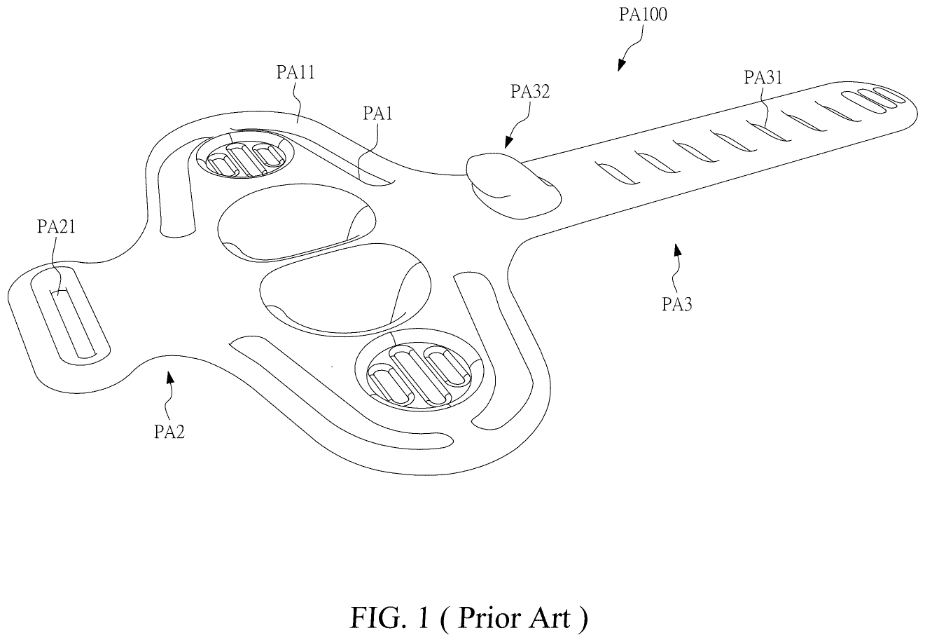

FIG. 2 is a perspective schematic diagram of a prior-art mobile device holder fastened onto a carrier after securing a mobile device;

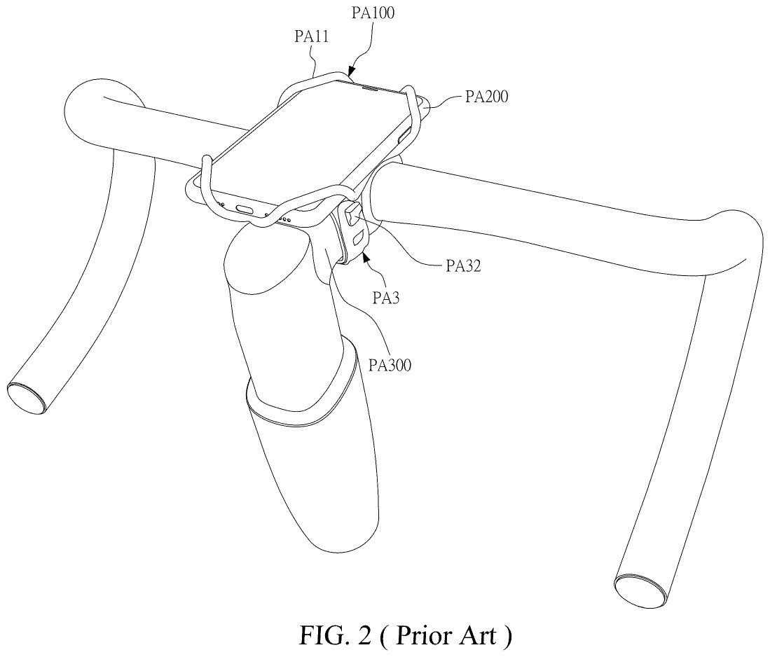

FIG. 3 shows a cross-sectional schematic diagram of a prior-art mobile device holder;

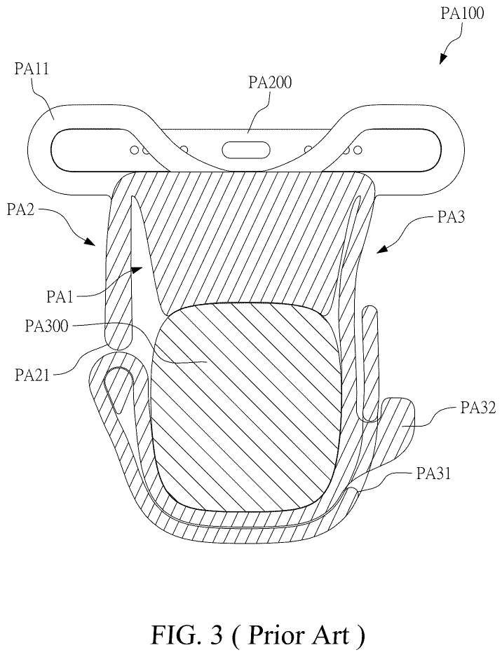

FIG. 4 is a perspective schematic diagram of a strap-type mobile device holder according to a first embodiment of the present invention;

FIG. 5 is a side schematic diagram of a strap-type mobile device holder according to a first embodiment of the present invention;

FIG. 6 is a perspective schematic diagram of a first elastic strap of a strap-type mobile device holder, according to a first embodiment of the present invention, passing through a second perforation;

FIG. 7 is a perspective schematic diagram of a strap-type mobile device holder, according to a first embodiment of the present invention, fastened onto a carrier;

FIG. 8 is a perspective schematic diagram from another side of a strap-type mobile device holder, according to a first embodiment of the present invention, fastened onto a carrier;

FIG. 9 is a cross-sectional schematic diagram of a strap-type mobile device holder, according to a first embodiment of the present invention, fastened onto a carrier;

FIG. 10 is a cross-sectional schematic diagram of a strap-type mobile device holder, according to a first embodiment of the present invention, fastened onto a smaller carrier;

FIG. 11 is a perspective schematic diagram of a strap-type mobile device holder according to a second embodiment of the present invention;

FIG. 12 is a perspective schematic diagram of a strap-type mobile device holder, according to a second embodiment of the present invention, securing the mobile device;

FIG. 13 is a perspective schematic diagram of a strap-type mobile device holder according to a third embodiment of the present invention;

FIG. 14 is a perspective schematic diagram of a strap-type mobile device holder, according to a third embodiment of the present invention, securing the mobile device;

FIG. 15 is a perspective schematic diagram of a strap-type mobile device holder according to a fourth embodiment of the present invention; and

FIG. 16 is a perspective schematic diagram of a strap-type mobile device holder, according to a fourth embodiment of the present invention, securing the mobile device.

### DETAILED DESCRIPTION OF THE EMBODIMENTS

Since the strap-type mobile device holder of the present invention has a plurality of different mobile device securing methods, they will not be redundantly described in detail here. Only a few preferred embodiments will be specifically illustrated, and these embodiments are exemplified solely to conveniently and clearly assist in explaining the purpose and effectiveness of the present invention.

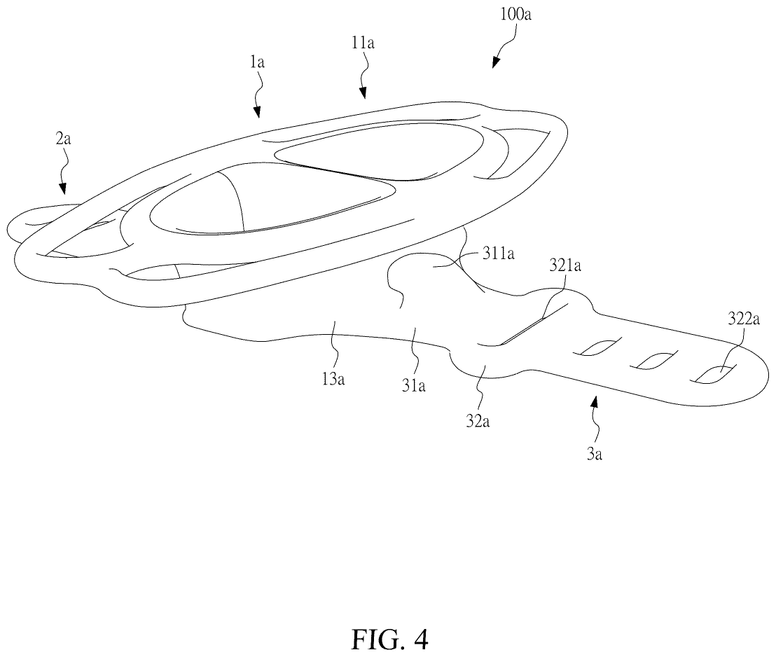

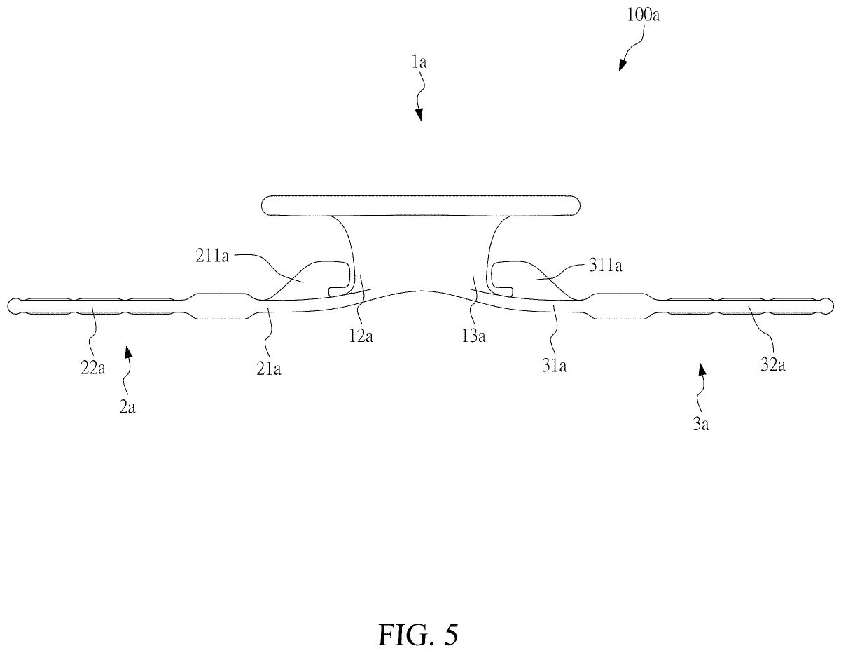

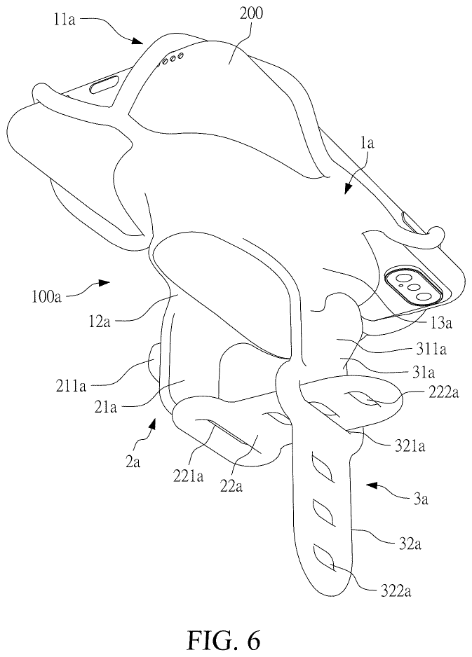

Please refer to FIG. 4 to FIG. 6, where FIG. 4 is a perspective schematic diagram of a strap-type mobile device holder according to a first embodiment of the present invention; FIG. 5 is a side schematic diagram of a strap-type mobile device holder according to a first embodiment of the present invention; and FIG. 6 is a perspective schematic diagram of a first elastic strap of a strap-type mobile device holder, according to a first embodiment of the present invention, passing through a second perforation.

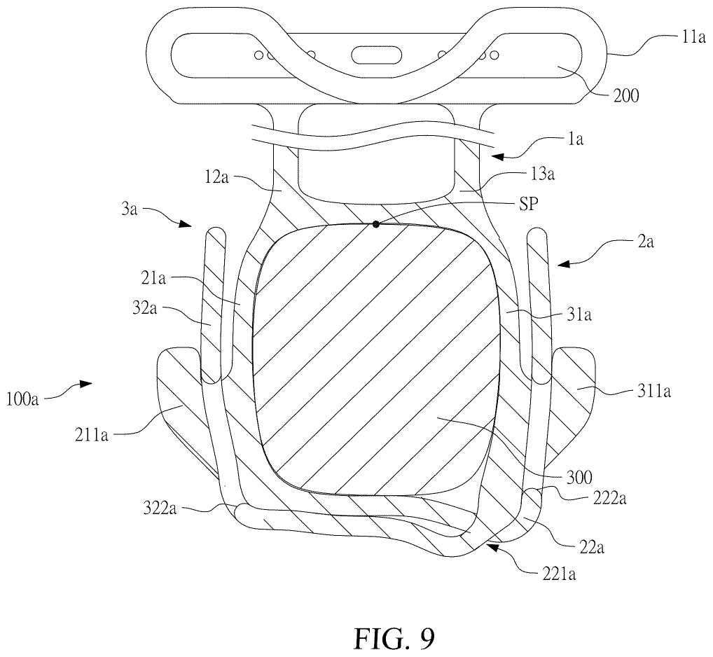

As shown in FIG. 4 to FIG. 6, in the first embodiment, a strap-type mobile device holder 100a is configured to be fastened to a selected fixed position SP (marked in FIG. 9) on a carrier 300 after securing a mobile device 200, thereby ensuring that the mobile device 200 remains fastened to the selected fixed position SP even when the carrier 300 is in motion Preferably, the strap-type mobile device holder 100a is an integrally formed component.

In this embodiment, the mobile device 200 is a smart phone, but is not limited thereto. In other embodiments, the mobile device 200 may be, for example, a portable music player, a navigation device, a tablet computer, or even a water bottle or other portable devices.

In this embodiment, the carrier 300 is a bicycle (for example, the support column or handlebar of the bicycle), but is not limited thereto. In other embodiments, the carrier 300 may be, for example, a person's arm or any other object that can be fastened.

Structurally, the strap-type mobile device holder 100a includes a holder body 1a, a first elastic strap 2a, and a second elastic strap 3a. The holder body 1a is provided with a secure structure 11a configured to secure the mobile device 200 and includes a first connecting portion 12a and a second connecting portion 13a positioned opposite each other. In the first embodiment, the secure structure 11a includes four elastic loop cords configured to elastically wrap around and secure the mobile device 200. Preferably, the holder body 1a is an integrally formed component.

The first elastic strap 2a includes a first solid section 21a and a first perforated section 22a. The first solid section 21a extends outward from the first connecting portion 12a in a direction away from the second connecting portion 13a, and is provided with a first buckle portion 211a. The first perforated section 22a extends outward from the first solid section 21a in a direction away from the holder body 1a, and is provided with a first perforation 221a adjacent to the first solid section 21a and at least one first buckle hole away from the first solid section 21a. In this embodiment, a plurality of first buckle holes are provided, with only one first buckle hole 222a specifically marked. Preferably, the first elastic strap 2a is an integrally formed component.

The second elastic strap 3a includes a second solid section 31a and a second perforated section 32a. The second solid section 31a extends outward from the second connecting portion 13a in a direction away from the first connecting portion 12a, and is provided with a second buckle portion 311a. The second perforated section 32a extends outward from the second solid section 31a in a direction away from the holder body 1a, and is provided with a second perforation 321a adjacent to the second solid section 31a and at least one second buckle hole away from the second solid section 31a. In this embodiment, a plurality of second buckle holes are provided, with only one second buckle hole 322a specifically marked. Preferably, the second elastic strap 3a is an integrally formed component.

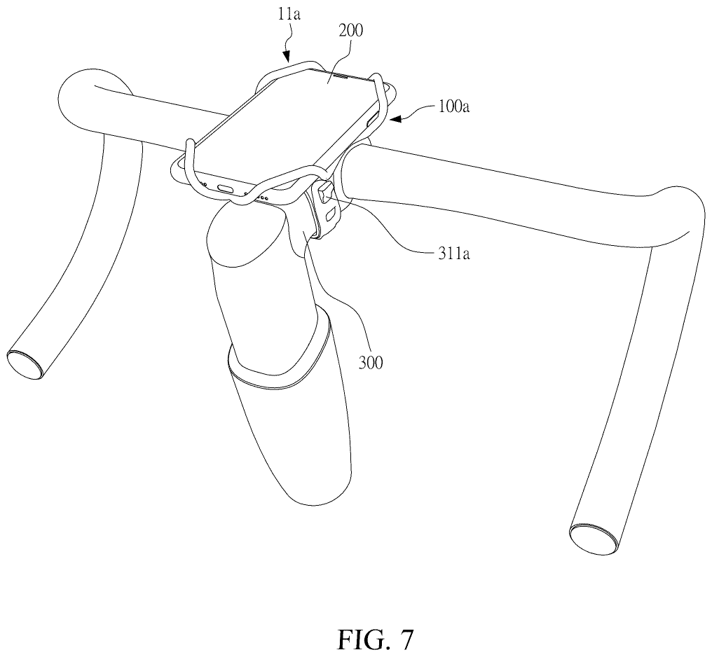

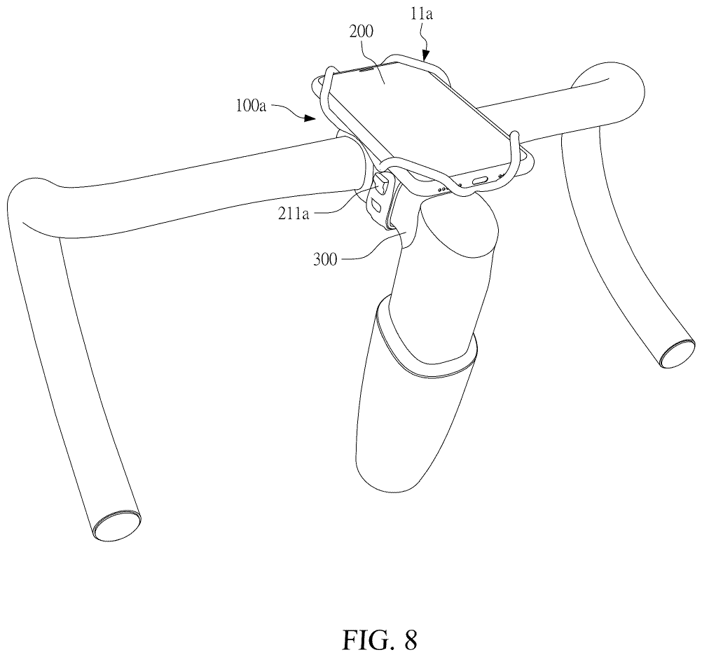

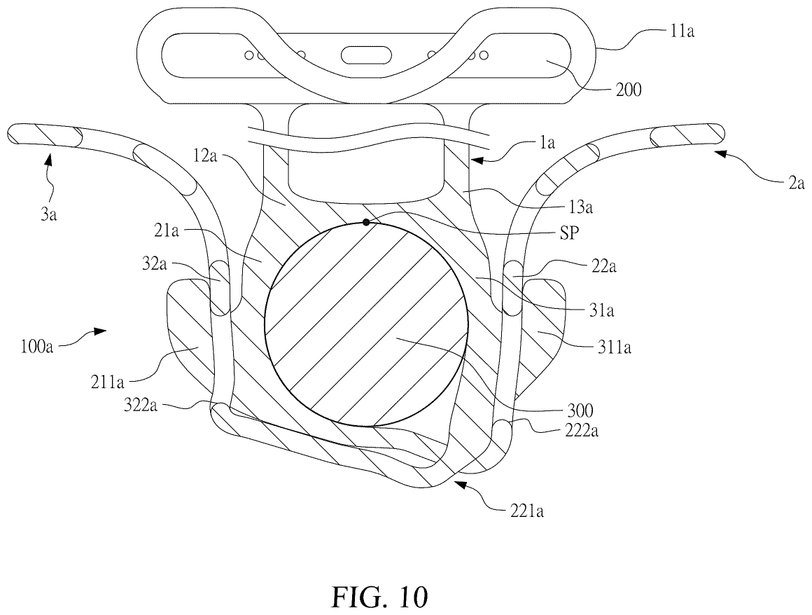

Please refer to FIG. 7 to FIG. 9, where FIG. 7 is a perspective schematic diagram of a strap-type mobile device holder, according to a first embodiment of the present invention, fastened onto a carrier; FIG. 8 is a perspective schematic diagram from another side of a strap-type mobile device holder, according to a first embodiment of the present invention, fastened onto a carrier; FIG. 9 is a cross-sectional schematic diagram of a strap-type mobile device holder, according to a first embodiment of the present invention, fastened onto a carrier; and FIG. 10 is a cross-sectional schematic diagram of a strap-type mobile device holder, according to a first embodiment of the present invention, fastened onto a smaller carrier.

As shown in FIG. 7 to FIG. 10 (the cross-sectional schematic diagrams are for reference only and the perspective structure in this embodiment is primarily as shown in FIG. 4 to FIG. 6), when fastening the strap-type mobile device holder 100a with secured mobile device 200 to the selected fixed position SP of the carrier 300, the first elastic strap 2a loops around the carrier 300 and passes through the second perforation 321a, or the second elastic strap 3a loops around the carrier 300 and passes through the first perforation 221a, such that the first buckle hole 222a is engaged with the second buckle portion 311a, and the second buckle hole 322a is engaged with the first buckle portion 211a, thereby fastening the strap-type mobile device holder 100a to the selected fixed position SP by a bidirectional buckle mechanism.

Compared to the prior art, since the first elastic strap 2a and the second elastic strap 3a of the present invention have equal (or similar) length, and the buckle positions (where the first buckle portion 211a is engaged with the second buckle hole 322a, and the second buckle portion 311a is engaged with the first buckle hole 222a) are symmetrical without lateral offset.

In other words, after fastening onto a carrier 300, the elastic recovery forces (in the form of friction) generated by the first elastic strap 2a and the second elastic strap 3a mutually cancel out when acting on the surface of the carrier 300, preventing any unbalanced torque that could cause the strap-type mobile device holder 100a to flip over. Even if the carrier 300 vibrates during movement, the strap-type mobile device holder 100a remains stable.

Additionally, since the strap-type mobile device holder 100a of the present invention is provided with two buckle portions (the first buckle portion 211a and the second buckle portion 311a), if vibrations of the carrier 300 cause one buckle hole to detach from a buckle portion, the other buckle portion can still secure the strap-type mobile device holder 100a onto the carrier 300, effectively preventing the mobile device 200 from falling and being damaged.

In the present invention, fastening to the selected fixed position SP not only indicates that there will be no relative movement or sliding between the strap-type mobile device holder 100a and the carrier 300, but also means there will be no relative rotation between the strap-type mobile device holder 100a and carrier 300.

As shown in FIG. 10, since the first perforated section 22a is provided with a plurality of first buckle holes, and the second perforated section 32a is provided with a plurality of second buckle holes, it is possible to enhance the fastening torque of the first elastic strap 2a and the second elastic strap 3a at the selected fixed position SP by engaging the first buckle portion 211a with a second buckle hole closer to the second solid section 31a, and engaging the second buckle portion 311a with a first buckle hole closer to the first solid section 21a.

The fastening torque is influenced by factors such as the weight, center of gravity, and contact area of the strap-type mobile device holder 100a. The tighter the straps are pulled, the greater the tension generated, resulting in a higher fastening torque. By increasing the fastening torque, the stability of the strap-type mobile device holder 100a can be improved when fastening the strap-type mobile device holder 100a onto a thinner carrier 300 (for example, the bicycle handlebar or support column of a bicycle).

In other embodiments, a plurality of first buckle holes may be provided only on the first perforated section 22a, or a plurality of second buckle holes may be provided only on the second perforated section 32a. However, providing a plurality of buckle holes on only one side may result in lateral offset of the buckle positions, making it relatively less stable.

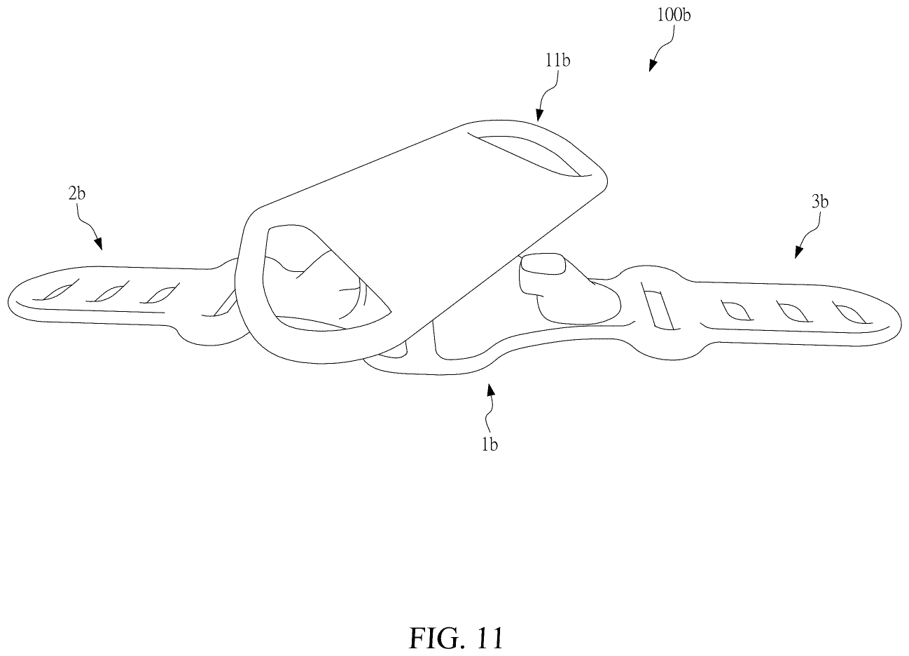

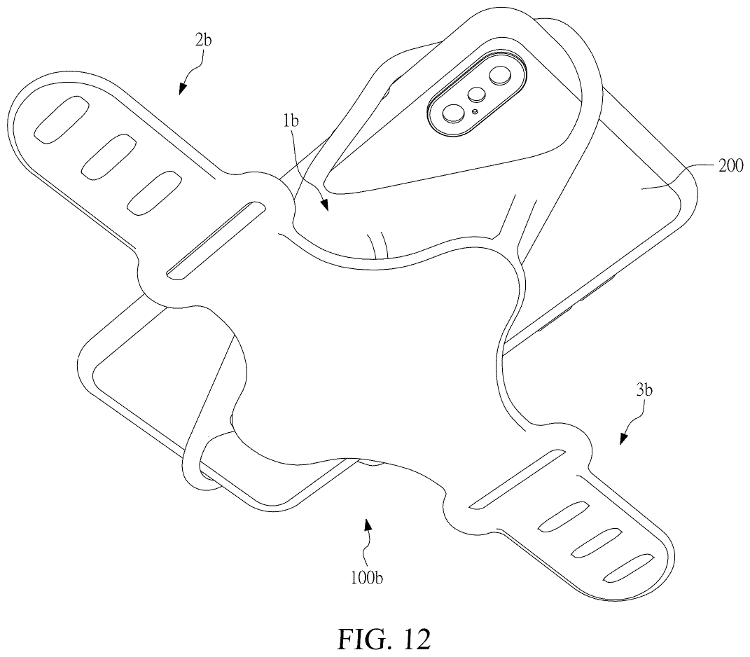

Please refer to FIG. 11 and FIG. 12, where FIG. 11 is a perspective schematic diagram of a strap-type mobile device holder according to a second embodiment of the present invention; and FIG. 12 is a perspective schematic diagram of a strap-type mobile device holder, according to a second embodiment of the present invention, securing the mobile device.

As shown in FIG. 11 and FIG. 12, the strap-type mobile device holder 100b in the second embodiment also includes a holder body 1b, a first elastic strap 2b, and a second elastic strap 3b, and the method of fastening onto a carrier 300 is the same as in the first embodiment. Please refer to the corresponding paragraphs for details, as this embodiment does not redundantly describe the fastening method.

The difference between the second embodiment and the first embodiment is that the secure structure 11b in the second embodiment only includes two elastic loop cords, which are configured to elastically wrap around and secure the mobile device 200. By reducing the number of elastic loop cords, material costs can be effectively lowered while maintaining sufficient secure strength, thereby improving the economic efficiency of the product.

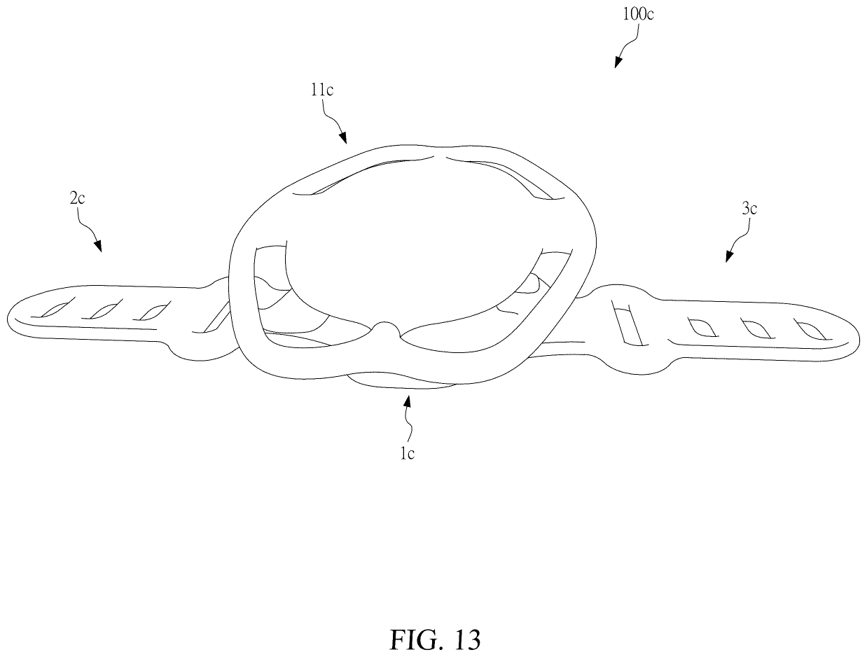

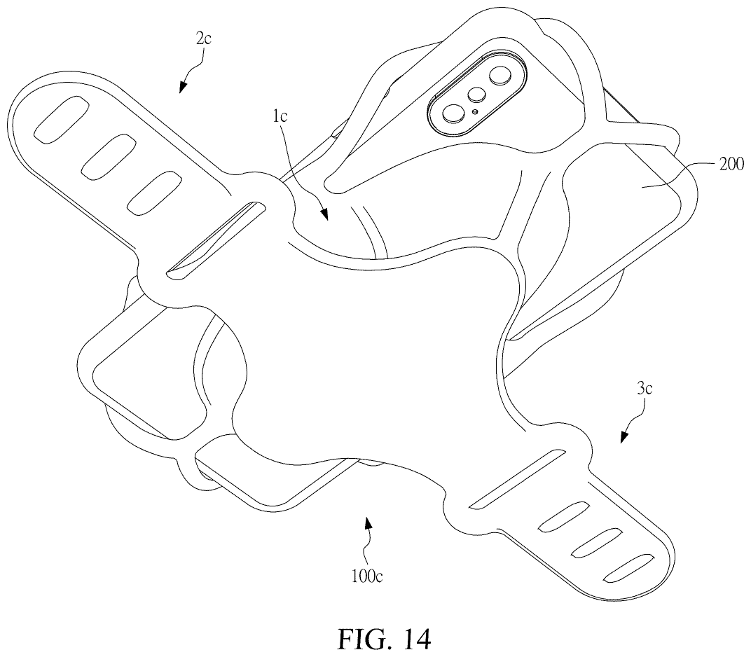

Please refer to FIG. 13 and FIG. 14, where FIG. 13 is a perspective schematic diagram of a strap-type mobile device holder according to a third embodiment of the present invention; and FIG. 14 is a perspective schematic diagram of a strap-type mobile device holder, according to a third embodiment of the present invention, securing the mobile device.

As shown in FIG. 13 and FIG. 14, the strap-type mobile device holder 100c in the third embodiment also includes a holder body 1c, a first elastic strap 2c, and a second elastic strap 3c, and the method of fastening onto a carrier 300 is the same as in the first embodiment. Please refer to the corresponding paragraphs for details, as this embodiment does not redundantly describe the fastening method.

The difference between the third embodiment and the second embodiment is that the secure structure 11c in the third embodiment includes two elastic protective sleeves, which are configured to elastically wrap around and secure the mobile device 200. Compared to the same number of elastic loop cords, the elastic protective sleeves have a larger contact area with the mobile device 200, providing better secure stability. Additionally, in this embodiment, when the elastic protective sleeves secure the mobile device 200, a camera module (not labeled) of the mobile device 200 is avoided. In other words, even if the camera module continues to increase in size, the secure structure 11c in this embodiment can still stably secure the mobile device 200.

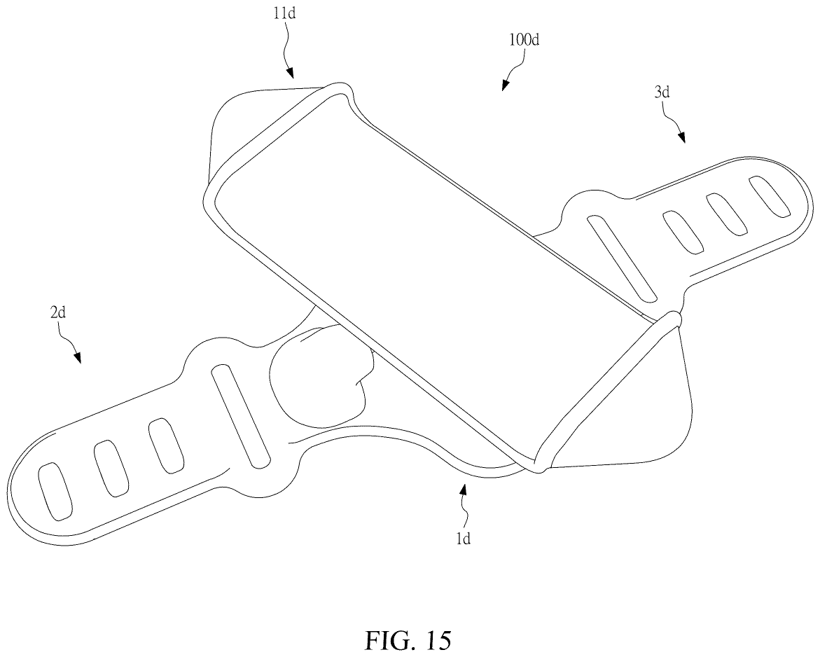

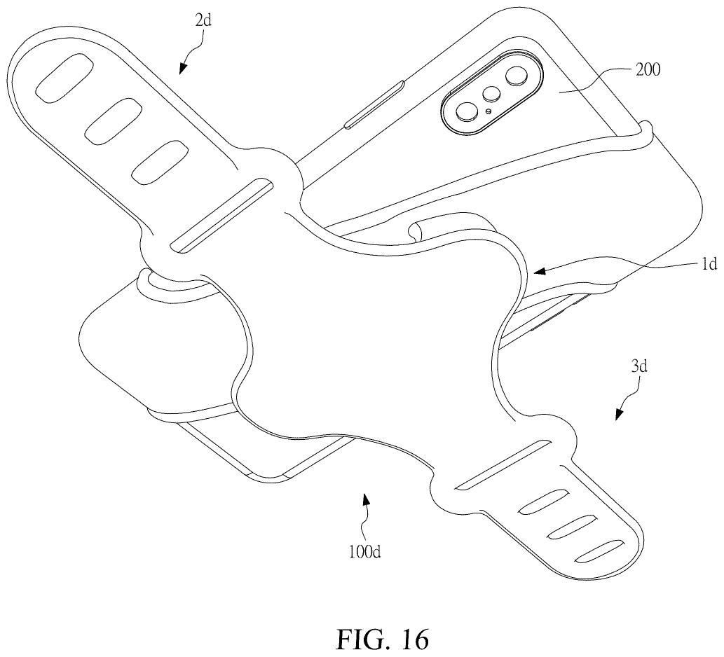

Please refer to FIG. 15 and FIG. 16, where FIG. 15 is a perspective schematic diagram of a strap-type mobile device holder according to a fourth embodiment of the present invention; and FIG. 16 is a perspective schematic diagram of a strap-type mobile device holder, according to a fourth embodiment of the present invention, securing the mobile device.

As shown in FIG. 15 and FIG. 16, the strap-type mobile device holder 100d in the fourth embodiment also includes a holder body 1d, a first elastic strap 2d, and a second elastic strap 3d, and the method of fastening onto a carrier 300 is the same as in the first embodiment. Please refer to the corresponding paragraphs for details, as this embodiment does not redundantly describe the fastening method.

The secure structure 11d in the fourth embodiment is the same or similar to the secure structure 11a in the first embodiment. The difference between the fourth embodiment and the first embodiment is that the holder body 1d does not have a groove (not labeled). Compared to the holder body 1a, which is provided with a groove, the holder body 1d has a larger contact area with the mobile device 200, thus offering higher secure stability.

In summary, the strap-type mobile device holder 100a provided by the present invention uses a bidirectional buckle mechanism with the first elastic strap 2a and the second elastic strap 3a of the same (or similar) length to fasten onto a carrier 300, featuring symmetrical buckle positions. This allows the elastic recovery forces to mutually cancel out, preventing unbalanced torque that could cause the strap-type mobile device holder 100a to flip over due to vibrations when the carrier 300 is in motion.

Additionally, since the strap-type mobile device holder 100a provided by the present invention is provided with two buckle portions, if vibrations from the carrier 300 cause one buckle hole to detach from a buckle portion, the other buckle portion can still secure the strap-type mobile device holder 100a onto the carrier 300, effectively preventing the mobile device 200 from falling and being damaged.

Through the detailed descriptions of the above preferred embodiments, the purpose is to more clearly illustrate the features and spirit of the present invention, rather than to limit its scope to the disclosed preferred embodiments. On the contrary, the intent is to encompass various modifications and equivalent arrangements within the scope of the patent claims for which the present invention seeks protection.

What is claimed is:

1. A strap-type mobile device holder configured to be fastened to a selected fixed position on a carrier after securing the mobile device, ensuring that the mobile device remains fastened onto the selected fixed position even when the carrier is in motion, the strap-type mobile device holder comprising:
a holder body provided with a secure structure configured to secure the mobile device and comprising a first connecting portion and a second connecting portion positioned opposite each other;
a first elastic strap comprising:
a first solid section extending outward from the first connecting portion in a direction away from the second connecting portion and provided with a first buckle portion; and
a first perforated section extending outward from the first solid section in a direction away from the holder body and provided with a first perforation positioned adjacent to the first solid section and at least one first buckle hole positioned away from the first solid section; and
a second elastic strap comprises:
a second solid section extending outward from the second connecting portion in a direction away from the first connecting portion and provided with a second buckle portion; and
a second perforated section extending outward from the second solid section in a direction away from the holder body and provided with a second perforation positioned adjacent to the second solid section and at least one second buckle hole positioned away from the second solid section;
wherein, when fastening the strap-type mobile device holder secured with the mobile device onto the selected fixed position on the carrier, the first elastic strap loops around the carrier and passes through the second perforation or the second elastic strap loops around the carrier and passes through the first perforation, such that the at least one first buckle hole engages with the second buckle portion and the at least one second buckle hole engages with the first buckle portion, thereby securing the strap-type mobile device holder onto the selected fixed position by a bidirectional buckle mechanism.

2. The strap-type mobile device holder of claim 1, wherein the first perforated section is provided with the at least one first buckle hole and the second perforated section is provided with the at least one second buckle hole so as to selectively engage one of the at least one first buckle hole with the second buckle portion and selectively engage one of the at least one second buckle hole with the first buckle portion, thereby adjusting fastening torques of the first elastic strap and the second elastic strap at the selected fixed position.

3. The strap-type mobile device holder of claim 1, wherein the strap-type mobile device holder is an integrally formed component.

4. The strap-type mobile device holder of claim 1, wherein the first elastic strap and the second elastic strap are both integrally formed components.

5. The strap-type mobile device holder of claim 1, wherein the holder body is an integrally formed component.

6. The strap-type mobile device holder of claim 1, wherein the secure structure comprises a plurality of elastic loop cords configured to elastically wrap around and secure the mobile device.

7. The strap-type mobile device holder of claim 1, wherein the secure structure comprises a plurality of elastic protective sleeves configured to elastically wrap around and secure the mobile device.
